(19) United States
(12) Patent Application Publication
(10) Pub. No.: US 2006/0177622 A1
(43) Pub. Date: Aug. 10, 2006

(54) Structure of double-side optical storage medium

(76) Inventors: Wu-Hsuan Ho, Hsinchu (TW); Chung-Ping Wang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/052,066

(22) Filed: Feb. 8, 2005

(51) Int. Cl. B32B 3/02

(52) U.S. Cl. 428/64.4

(57) ABSTRACT

The present invention provides a structure of a double-side optical storage medium, which comprises a substrate possessing two surfaces, wherein each surface has a read/write structure. Via installing two read/write structures separately onto the top and the bottom surface of the substrate, the capacity of the optical storage medium is doubled, and the manufacture difficulty is reduced, and further the manufacture cost is lowered.

### BACKGROUND OF THE INVENTION

1. Field of the Invention

The present invention relates to a structure of an optical storage medium, particularly to a structure of a double-side optical storage medium.

2. Description of Related Art

Evolving with the age of information and multi-media, a storage medium needs a higher data-storage density and data-storage capacity to satisfy the current demand of the data storage, and the high-capacity Digital Versatile Disc (DVD) plays an important role therein. The capacity of DVD depends on the disc structure itself and the spot size of the laser light used in the read/write device. The optical system of the conventional 23.3 GB blu-ray disc (BD) adopts a laser light of about 405 nm wavelength and a focusing lens of about 0.85 numerical aperture (NA), which enables the focused laser light to has a spot size of about 0.3 μm in diameter; the disc structure thereof adopts a structure of single side-double layer.

As shown in FIG. 1, the structure of a conventional optical storage medium, of blue-ray “single-side/double-layer” read/write structure, comprises a substrate 10 and two read/write layers 12 installed onto the substrate 10 sequentially, wherein each read/write layer 12 comprises a plurality of films, and those films include at least a dielectric layer, a recording layer and a reflective layer.

In the aforementioned structure of the conventional optical storage medium, a 0.1 mm cover layer needs to be formed, which makes the fabrication of that optical storage medium difficult, needless to mention that a space layer needs to be formed between two read/write layers 12; thus, the fabricating cost thereof is pretty high. Further, owing to the reading/writing of the double layers, a layer cross talk is apt to occur, which induces a signal interference. Besides, the write power must be enhanced in order to overcome the problem of reading/writing of the double layers, which induces the technical threshold and price of that read/write device to be rather high.

As shown in FIG. 2, the structure of a conventional optical storage medium, of double-side/single-layer DVD, adopts a red laser light with its wavelength ranging from 635 to 660 nm, and comprises: a first substrate 14, a second substrate 16, and two read/write layers 18 installed between the first substrate 14 and the second substrate 16, wherein each read/write layer 18 comprises a plurality of films, and those films include an top and a bottom dielectric layer, a recording layer and a reflective layer.

As the red light, which has a longer wavelength, is adopted in the above-mentioned conventional technology, the focused point is relatively large, which results in a lower read/write density; thus, the data-storage capacity thereof decreases.

In re the problems of the conventional technology mentioned above, the present invention provides a structure of double-side optical storage medium utilizing a blue laser light in order to overcome the drawbacks thereof.

### SUMMARY OF THE INVENTION

The primary objective of the present invention is to provide a structure of double-side optical storage medium, wherein via installing read/write structures separately onto the top and the bottom surface of the substrate, the data-storage capacity is doubled.

Another objective of the present invention is to provide a structure of double-side optical storage medium, which is distinct from the conventional single-side/double-layer optical storage medium, wherein, via installing read/write structures separately onto the top and the bottom surface of the substrate, the manufacturing process thereof is exempt from the fabrication of the space layer; thus the fabricating cost is reduced.

Further another objective of the present invention is to provide a structure of double-side optical storage medium, wherein as the read/write structure is installed on the surface of the substrate, the read/write distance decreases, and a laser light source of shorter wavelength and a larger numerical aperture can be adopted, so that the extent of the data densification of the optical storage medium increases.

According to the present invention, the structure of double-side optical storage medium comprises a substrate, which possesses a top surface and a bottom surface, and two read/write structures, which are separately installed onto the top and the bottom surface.

Via the following detailed description of the embodiments in cooperation with the attached drawings, the objectives, technical contents, characteristics, and accomplishments of the present invention are to be more easily understood.

### BRIEF DESCRIPTION OF THE DRAWINGS

FIG. 1 is a sectional view of a conventional single-side/double-layer structure.

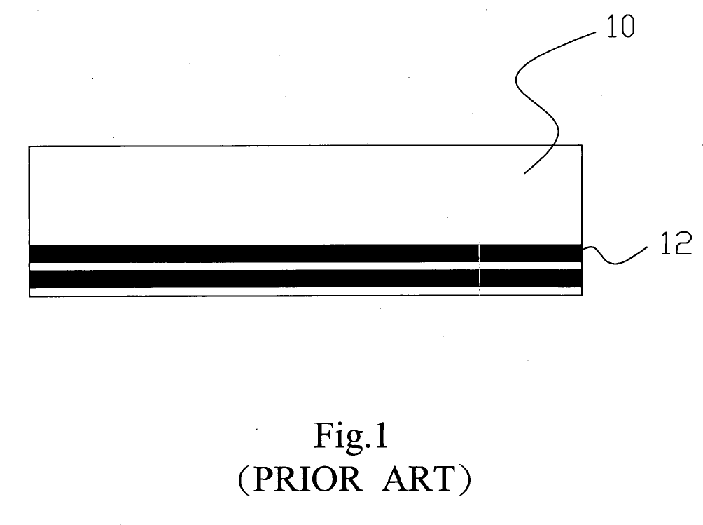

FIG. 2 is a sectional view of a conventional double-side/double-layer structure.

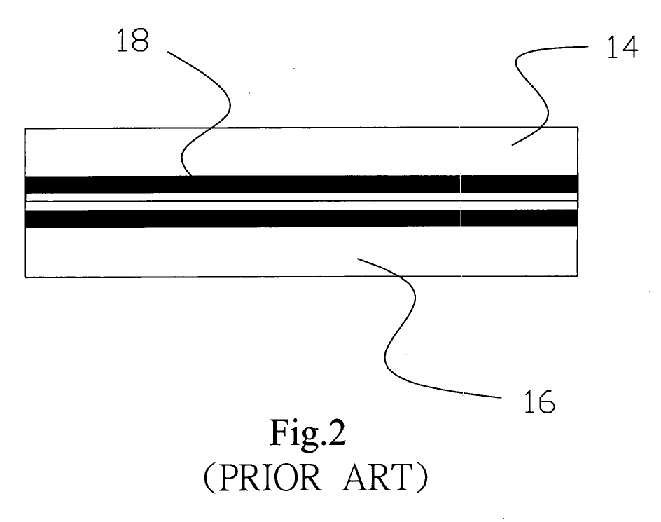

FIG. 3 is an exploded view of the structure of one embodiment of the present invention.

FIG. 4 is a sectional view of the structure of one embodiment of the present invention.

FIG. 5 is a magnified sectional view of the localized structure of one embodiment of the present invention.

FIG. 6 is a structural sectional view of the present invention's application in a read-only optical storage medium.

FIG. 7 is a structural sectional view of the present invention's application in a complex optical storage medium.

### THE PREFERRED EMBODIMENTS OF THE PRESENT INVENTION

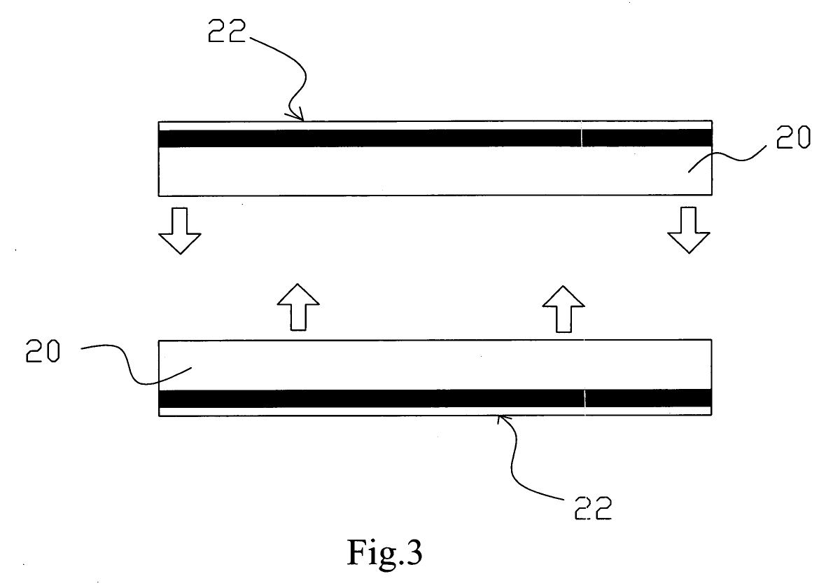

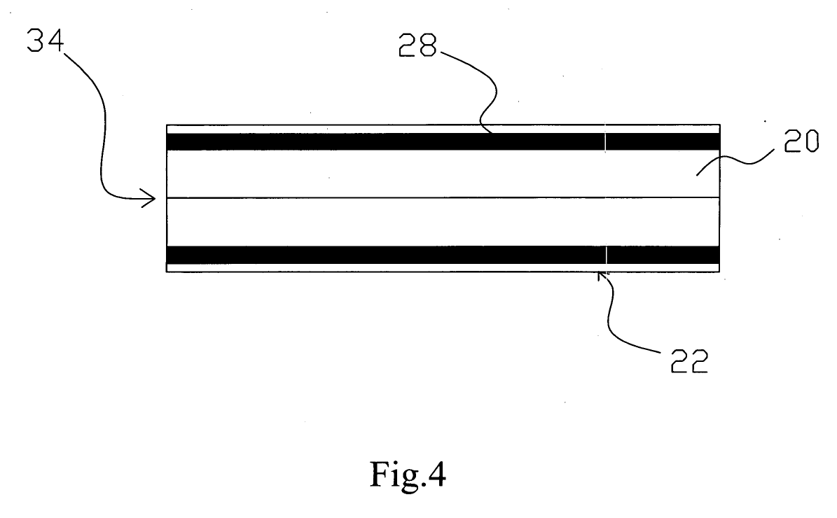

As shown in FIG. 3 and FIG. 4, the structure of double-side optical storage medium proposed by the present invention comprises: two transparent plates 20, each of which is made of a polycarbonate material and has a diameter of either 8 cm or 12 cm and also has a top and a bottom surface; and two read/write structures 22, each of which is separately installed onto each top surface of two transparent plates 20.

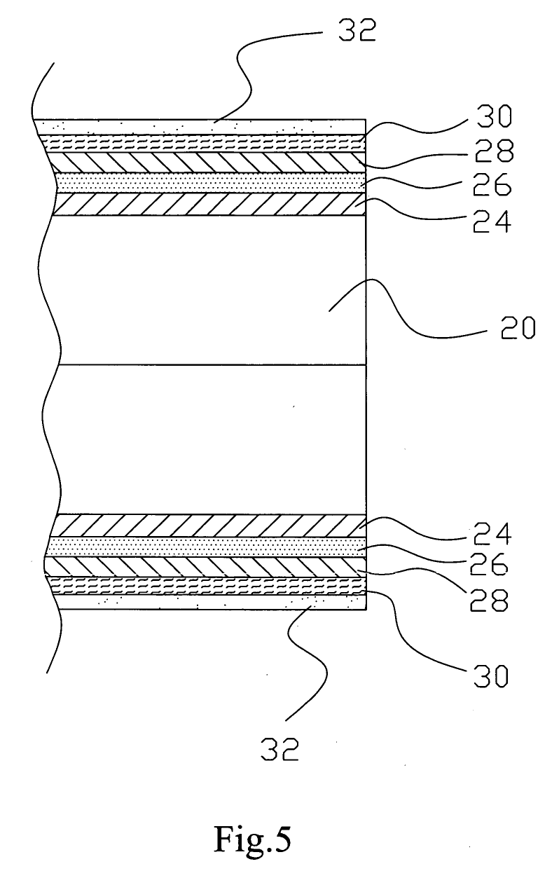

Referring to FIG. 5, the read/write structure 22 comprises the following elements presented in a bottom-up sequence: reflective layer 24, bottom dielectric layer 26, phase-transformation recoding layer 28 and top dielectric layer 30. Further, a transparent protective layer 32 can be installed onto the read/write structure 22 in order to improve the problem of the read/write errors resulting from abrasion or pollution.

After the above description of the read/write structure 22, the materials of each layer thereof will be described below. The material of the phase-transformation recoding layer 28 is composed of Germanium (Ge), Indium (In), Antimony (Sb) and Tellurium (Te), GeBiTe or GeSbTe-related materials. The material of the top and the bottom dielectric layer is composed of materials with thermal conductivity lower than that of the recording material, such as Germanium compound, Silicon Nitride (SiN), or ZnS—SiO2, etc. The material of the reflective layer 24 is selected from Silver (Ag) or silver alloy.

After sequentially installing the read/write structures 22 and the transparent protective cover layers 32 onto two transparent plates 20, the bottom surfaces of two transparent plates 20 are joined together face to face to form a substrate 34 with two read/write structures 22 separately on two externally-fronting surfaces of two transparent plates 20. Then, the optical storage medium is initialized to enable the phase-transformation recoding layer 28 to crystallize, and thus, the fabrication of the optical storage medium is completed. The abovementioned embodiment is the present invention's application in the phase-transformation type optical storage medium. Besides, the structure of the present invention also applies to the read-only type optical storage medium.

When reading/writing the optical storage medium, the laser light of wavelength ranging from 385 to 435 nm illuminates the optical storage medium to enable the phase-transformation recoding layer 28 to shift between a crystalline and an amorphous phase, and then, via the high reflectivity of the crystalline phase and the low reflectivity of the amorphous phase, the signal of 0 or 1 is identified.

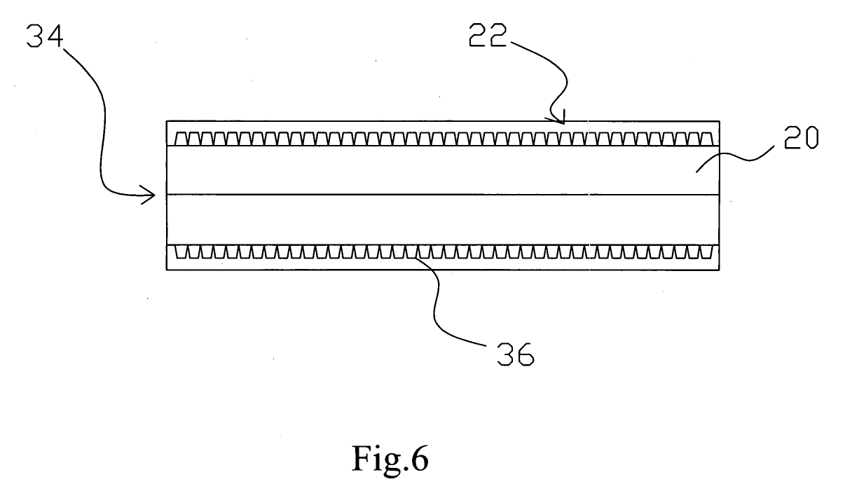

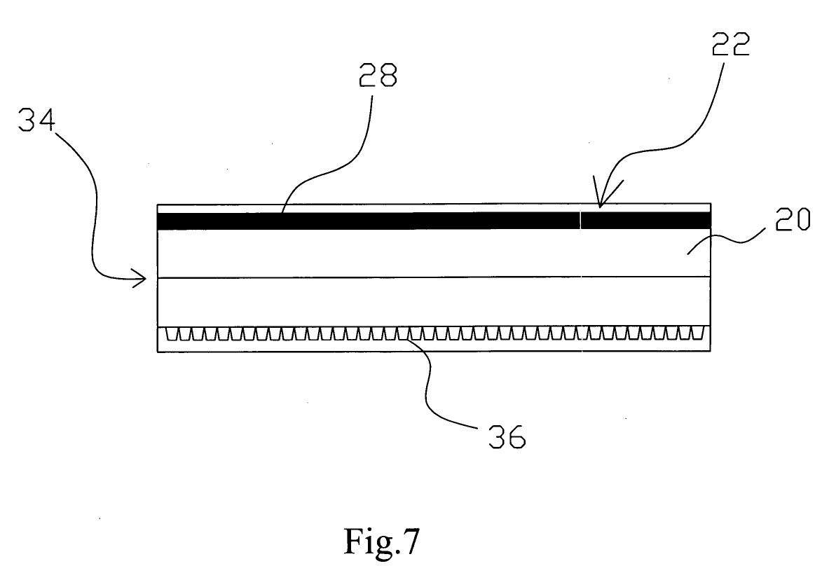

As shown in FIG. 6, the structure of optical storage medium applies to the read-only type optical storage medium, and two read-only information layers 36 are separately installed onto two transparent plates 20. When fabricating the disc, the data can be—prerecorded into the read-only information layer 36. Otherwise, an organic dye can be adopted as the recording layer's material, so that the data cannot be erased once having been written (i.e. the write-once disc). Besides, as shown in FIG. 7, this structure of optical storage medium also applies to the complex optical storage medium, and two different read/write structures 22 are separately installed onto two externally-fronting surfaces of two transparent plates 20, wherein a read/write structure 22 having the read-only information layer 36 is installed onto one transparent plate 20, and a read/write structure 22 having the phase-transformation recoding layer 28 or the organic-dye recording layer is installed onto the other transparent plate 20.

Accordingly, via installing two read/write structures 22 separately onto the top and the bottom surface of the substrate 34, the data-storage capacity of the optical storage medium is doubled. Further, via installing the read/write structure 22 onto the surface of the substrate 34, when the read/write device operates, the read/write distance can be reduced, and thus, the laser light source of shorter wavelength and larger numerical aperture can be adopted in order to promote the extent of the data densification of the optical storage medium.

What is claimed is:

1. A structure of double-side optical storage medium, comprising:
a substrate, which has a top and a bottom surface; and
at least two read/write structures, which are separately installed onto said top and said bottom surface of said substrate.

2. The structure of double-side optical storage medium according to claim 1, wherein said read/write structure on said top surface of said substrate comprises at least the following elements presented in the bottom-up sequence: a first reflective layer, a first bottom dielectric layer, a first recording layer, and a first top dielectric layer, and said read/write structure on said bottom surface of said substrate comprises at least the following elements presented in the top-down sequence: a second reflective layer, a second bottom dielectric layer, a second recording layer, and a second top dielectric layer.

3. The structure of double-side optical storage medium according to claim 2, wherein the material of two said dielectric layers is selected from a Germanium compound, a Silicon Nitride (SiN), or a ZnS—SiO₂.

4. The structure of double-side optical storage medium according to claim 2, wherein two said recording layers are composed of Germanium (Ge), Indium (In), Antimony (Sb) and Tellurium (Te), GeBiTe or a GeSbTe-related material.

5. The structure of double-side optical storage medium according to claim 2, wherein the material of two said reflective layers is selected from a silver alloy or Silver.

6. The structure of double-side optical storage medium according to claim 1, which further comprises two transparent protective cover layers separately installed over each of said read/write structures in order to improve the problem of the read/write errors resulting from abrasion or pollution.

7. The structure of double-side optical storage medium according to claim 1, wherein the material of said substrate is a polycarbonate.

8. The structure of double-side optical storage medium according to claim 1, wherein each of said read/write structures is selected from an organic-dye type one, a phase-transformation type one, or a read-only type one, or other type of information layer structures

9. The structure of double-side optical storage medium according to claim 8, wherein two said read/write structures can be of the same ones, or separately selected from the organic-dye type one, the phase-transformation type one, or the read-only type one.

10. The structure of double-side optical storage medium according to claim 1, wherein the wavelength of the read/write light source of said read/write structures ranges from 385 to 435 nm.

11. The structure of double-side optical storage medium according to claim 1, wherein the diameter of said substrate is either 8 cm or 12 cm.

12. The structure of double-side optical storage medium according to claim 1, said substrate is formed via gluing two transparent plates together.
